(19) United States
(12) Patent Application Publication
(10) Pub. No.: US 2025/0285352 A1
(43) Pub. Date: Sep. 11, 2025

(54) VISUAL MEDIA-BASED MULTIMODAL CHATBOT

(71) Applicant: YONUX LLC, Baltimore, MD (US)

(72) Inventor: Jia XU, Hoboken, NJ (US)

(73) Assignee: YONUX LLC, Baltimore, MD (US)

(21) Appl. No.: 19/216,030

(22) Filed: May 22, 2025

Related U.S. Application Data
(63) Continuation-in-part of application No. 18/809,234, filed on Aug. 19, 2024.
(63) Continuation-in-part of application No. 18/809,208, filed on Aug. 19, 2024.
(60) Provisional application No. 63/533,492, filed on Aug. 18, 2023.
(60) Provisional application No. 63/533,494, filed on Aug. 18, 2023.
(60) Provisional application No. 63/651,360, filed on May 23, 2024.

(51) Int. Cl. G06T 13/40; G06F 16/435; G06F 16/438

(52) U.S. Cl. CPC G06T 13/40; G06F 16/435; G06F 16/438

(57) ABSTRACT

Example embodiments of the present disclosure relate to a visual media-based multimodal chatbot. According to example embodiments, a method for operating a multimodal chatbot may include receiving a user input via a chatbot interface. The user input may include at least one of: a text, an audio, a first image, and a first video. The method may further include obtaining a visual media associated with the user input. The visual media may include at least one of: a second image, a second video, and an avatar associated with a person. The method may further include outputting the visual media via the chatbot interface.

### CROSS REFERENCE TO RELATED APPLICATIONS

This application claims priority to U.S. provisional application No. 63/651,360, filed with the U.S. Patent and Trademark Office on May 23, 2024, and is a continuation-in-part of U.S. patent application Ser. No. 18/809,234 (which claims priority to U.S. provisional application No. 63/533,492 filed on Aug. 18, 2023, and entitled “PERSONALIZED AVATAR DESIGN IN CHATBOT”) and U.S. patent application Ser. No. 18/809,208 (which claims priority to U.S. provisional application No. 63/533,494 filed on Aug. 18, 2023, and entitled “VISUAL MEDIA-BASED CHATBOT”), both filed with the U.S. Patent and Trademark Office on Aug. 19, 2024 and naming Jia Xu as the inventor, the disclosures of which are incorporated herein by reference in their entireties.

### TECHNICAL FIELD

Example embodiments of the present disclosure relate to a visual media-based multimodal chatbot, and more particularly, a multimodal chatbot that can receive, process, and output to various types of visual media in real time or near real time.

### BACKGROUND

The information disclosed in this background section is only for the enhancement of understanding of the general background of the disclosure and should not be taken as an acknowledgment or any form of suggestion that this information forms the prior art already known to a person skilled in the art.

Chatbots have facilitated digital communications by mimicking human-like interactions through text and voice responses. Accordingly, chatbots may serve a variety of functions from customer service to personal assistance on various digital platforms. For instance, chatbots may be used for simulating conversation with human users, as well as providing assistance, information, or facilitating services across various digital platforms, among other things. Chatbots may serve to streamline customer service, enhance user engagement, automate routine inquiries, support sales and marketing strategies, and offer quick access to information. This can include tasks like answering frequently asked questions (FAQs), guiding users through website navigation, helping with shopping or bookings, and providing round-the-clock support in multiple languages.

### SUMMARY

Example embodiments of the present disclosure provide devices, systems, devices, methods, and the like, that implement a visual media-based multimodal chatbot.

According to example embodiments, a method for operating a multimodal chatbot may include: receiving a user input via a chatbot interface, obtaining a visual media associated with the user input, understanding the media input, and outputting the visual media via the chatbot interface. The user input may include at least one of: a text, an audio, a first image, and a first video. The visual media may include at least one of: a second piece of text, a second image, a second video, and an avatar associated with a person.

According to example embodiments, the visual media may include at least one of: the second image and the second video. In this regard, the outputting the visual media may include: generating a visual media and a piece of text retrieval query based on the user input, retrieving a list of visual media associated with the user input from a database based on the visual media retrieval query, selecting the visual media from the list of visual media, and outputting the selected visual media via the chatbot interface. Additionally or alternatively, the outputting the visual media may include: generating a visual media generation instruction based on the user input, generating a list of visual media associated with the user input based on the visual media generation instruction, selecting the visual media from the list of visual media, and outputting the selected visual media via the chatbot interface. Additionally or alternatively, the outputting the visual media may include: generating a visual media retrieval query and a visual media generation instruction based on the user input, retrieving a first list of visual media associated with the user input from a database based on the visual media retrieval query, generating and/or retrieving a second list of visual media associated with the user input based on the visual media generation instruction and analogously for the third and many other lists, obtaining an ensemble of visual media based on the first list and second list of visual media, selecting the visual media from the ensemble of visual media based on at least one confidence score, and outputting the selected visual media via the chatbot interface.

According to example embodiments, the visual media may include the avatar. In this regard, the user input may include a text defining the person, and the outputting the visual media may include: searching an image associated with the person based on the user input, building an avatar figure based on the searched image, obtaining a visual media based on the user input, rendering the avatar based on the avatar figure and the visual media, and outputting the rendered avatar via the chatbot interface. Additionally or alternatively, the user input may include an image associated with the person, and the outputting the visual media may include: building an avatar figure based on the image comprised in the user input, obtaining a visual media based on the user input, rendering the avatar based on the avatar figure and the visual media, and outputting the rendered avatar via the chatbot interface. The avatar figure may be in two-dimensional (2D) and the rendered avatar may be in three-dimensional (3D).

According to example embodiments, the outputting the visual media may further include rendering a series of avatar movements via the chatbot interface. In this regard, the series of avatar movements may include at least one of: body movements, lip movements, changes in an avatar gesture, changes in an avatar pose, and changes in an avatar facial expression.

According to example embodiments, the method may further include: generating a chatbot response based on the user input, and presenting the chatbot response along with the visual media via the chatbot interface. The chatbot response may be visually distinguished from the visual media.

According to example embodiments, the method may further include or optionally include: receiving a user input via a chatbot interface, obtaining a visual media associated with the user input, understanding the user input and visual media, and outputting the visual media and a chatbot response via the chatbot interface. The user input may include at least one of: a first text, a first audio, a first image, and a first video. The visual media may include at least one of: a second image, a second video, and an avatar associated with a person, while the chatbot response may include at least one of: a second text and a second audio.

According to example embodiments, the method may further include or optionally include: generating the chatbot response based on the user input, generating a visual media retrieval query based on the user input, retrieving a list of visual media associated with the user input from a database based on the visual media retrieval query, selecting the visual media from the list of visual media, and outputting the selected visual media and chatbot response via the chatbot interface. Additionally or alternatively, the method may include: generating the chatbot response based on the user input, generating a visual media generation instruction based on the user input, generating a list of visual media associated with the user input based on the visual media generation instruction, selecting the visual media from the list of visual media, and outputting the selected visual media and the chatbot response via the chatbot interface. Additionally or alternatively, the method may include: generating the chatbot response based on the user input, generating a visual media retrieval query and a visual media generation instruction based on the user input, retrieving a first list of visual media associated with the user input from a database based on the visual media retrieval query, generating a second list of visual media associated with the user input based on the visual media generation instruction, obtaining an ensemble of visual media based on the first list and second list of visual media, selecting the visual media from the ensemble of visual media based on at least one confidence score, and outputting the selected visual media and the chatbot response via the chatbot interface. According to example embodiments, the method may further include generating and/or retrieving further lists of visual media (e.g., a third list of visual media and analogously for many other lists), selecting a visual media from the lists, and outputting the selected visual media (and chatbot response, if any) via the chatbot interface.

According to example embodiments, one or more operations of the aforementioned method may be implemented by a computing device that includes a memory device and a processing device. For instance, the memory device may be configured to store computer-readable instructions, while the processing device may be communicatively coupled to the memory device and configured to implement a multimodal chatbot to perform one or more operations of the aforementioned method.

According to example embodiments, one or more operations of the aforementioned method may be implemented as a non-transitory computer-readable recording medium. For instance, the non-transitory computer-readable recording medium may have recorded thereon instructions executable by a computing device to cause the computing device to implement a multimodal chatbot to perform one or more operations of the aforementioned method.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example system configuration, according to one or more example embodiments;

FIG. 2 illustrates an exemplary generic process for operating a multimodal chatbot, according to one or more example embodiments;

FIG. 3 to FIG. 4 each illustrates an exemplary process for operating a multimodal chatbot to communicate with a user via a visual media, according to one or more example embodiments;

FIG. 5 to FIG. 6 each illustrates an exemplary process for operating a multimodal chatbot to display a personalized avatar, according to one or more example embodiments;

FIG. 7 to FIG. 11 each illustrates an example chatbot interface, according to one or more example embodiments; and

FIG. 12 illustrates an example implementation of a multimodal chatbot, according to one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B],” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Although chatbots and the associated technologies have been extensively researched and implemented over time, related art chatbots are limited to text or voice-based interactions. Particularly, in the related art, the user may only interact with the chatbots via providing text-based queries or prompts (or voice-based queries that are eventually converted into text-based queries via speech recognition technologies). This approach, however, confines the interaction modality since the user may not interact with the chatbots with visual media, such as images and videos. For example, the aforesaid approach may place an undue burden on the user, as the user needs to express or describe the visual media to the chatbot when the user would like to involve the images or videos in the conversation. Further, it can be challenging for the users (particularly less-experienced users) to accurately capture and express the nuances of the intended visual media, particularly, when the visual media involves complex scenes or detailed descriptions are required. Accordingly, the conventional approach may lead to potential misinterpretations of visual media and less effective chatbot responses.

Additionally, many consumer electronic devices (e.g., television sets, digital photo albums, etc.) have yet to be fully leveraged to support chatbot functionalities that accept user inputs other than text inputs (e.g., the users cannot interact with the chatbots implemented in these devices via voice command, visual media, etc.). On the other hand, content platforms (e.g., online media streaming platforms, traditional media platforms, etc.) also lack language interaction with the users. As a result, the restrictions of the chatbots in the related art hinder the development of a fully immersive user experience and limit the chatbots' capability to provide visual media based on user inputs and develop a deeper conversation with the users with visual media.

Example embodiments of the present disclosure, as described in the following, provide devices, systems, methods, and the like, that implement a visual media-based multimodal chatbot and ultimately address the shortcomings of the related art as described above.

Specifically, example embodiments implement a multimodal chatbot that is capable of receiving and processing various types of user input (including visual media like images and/or videos), and outputting various types of responses, such as text response, audio response, image response, and/or video response based thereon, in real time or near real time. Additionally or alternatively, the multimodal chatbot may also design and output a personalized avatar based on various types of user inputs (e.g., texts, images, audio, and/or videos), thereby displaying an avatar that resembles a user-intended character/person, simulating and enhancing the feeling of communicating and interacting with a real/actual character/person, in real time or near real time. Ultimately, example embodiments may enhance the user experiences in communicating and interacting with the chatbots, as well as improve the chatbots' capability to understand and generate contextually precise outputs.

It is contemplated that features, advantages, and significance of example embodiments described hereinabove are merely a portion of the present disclosure, and are not intended to be exhaustive or to limit the scope of the present disclosure. Further descriptions of the features, components, configuration, operations, implementations, and example use cases of the example embodiments of the present disclosure are provided in the following.

### Example System Configuration

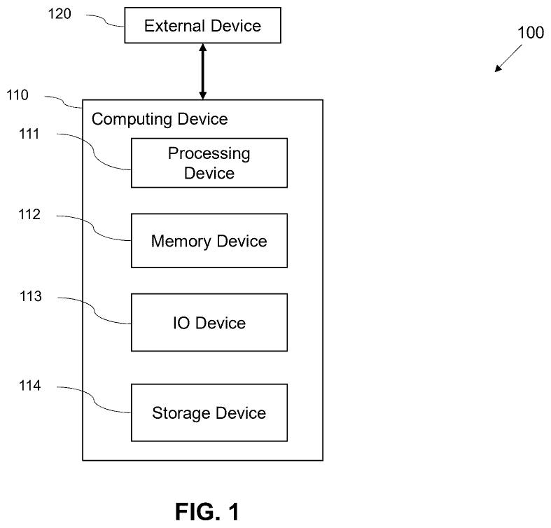

FIG. 1 illustrates an example system configuration 100, according to one or more example embodiments. As illustrated, system configuration 100 may include a computing device 110 and an external device 120. The computing device 110 may include at least one processing device 111, at least one memory device 112, at least one input/output (IO) device 113, and at least one storage device 114. It is contemplated that FIG. 1 is simplified for descriptive and illustrative purposes, and the scope of the present disclosure should not be limited thereto. Specifically, the system configuration 100 may include more/less components than as illustrated (e.g., multiple external devices 120 may be involved, the computing device 110 may include more/less components, etc.), without departing from the scope of the present disclosure.

The computing device 110 may include any type of device that can configured to implement a multimodal chatbot (or one or more associated operations described herein). Among other things, the computing device 110 may include a television, a digital photo album, a home assistant device, a computer, a mobile device, and/or any other suitable type of device having a display or screen that can be configured to display a visual output (e.g., a chatbot interface described herein). Additionally or alternatively, the computing device 110 may include a proprietary device that handles the computing tasks for implementing the chatbot (or one or more associated operations), such as a server, a high-performance computing (HPC) device, a cloud-based platform, a personal computer, and the like. In this case, the computing device 110 may provide information (e.g., instructions, control signals, visual media content, metadata, configuration parameters, etc.) to an external display or screen, such that the external display/screen may generate and display the visual output thereon. The computing device 110 may be a stand-alone device, an embedded system, or a plurality of devices, configured to perform one or more operations described herein. Furthermore, the computing device 110 may include or be part of any suitable consumer electronic devices (e.g., television sets, digital photo albums, etc.) and/or content platforms (e.g., online media streaming platforms, traditional media platforms, etc.).

Furthermore, the computing device 110 may communicate with the external device 120, via a wired connection (e.g., Ethernet connection, universal serial bus (USB) connection, fiber optic connection, cable connection, etc.), a wireless connection (e.g., Wi-Fi connection, Bluetooth connection, infrared connection, cellular network connection, near-field communication (NFC) connection, etc.), or a combination thereof. According to example embodiments, the computing device 110 may implement a software application that communicates with a software application of the external device 120 via one or more application programming interfaces (APIs),

The processing device 111 may be implemented in hardware, firmware, or a combination of hardware and software. Further, the processing device 111 may be configured to handle real-time (or near real-time/non-real-time) data processing and control of the computing device 110. The processing device 111 may be a programmable type, a dedicated, hardwired state machine, or a combination thereof. Further, the processing device 111 may include one or more of: an arithmetic-logic unit (ALU), a central processing unit (CPU), a graphics processing unit (GPU), a neural processing unit (NPU), a tensor processing unit (TPU), an accelerated processing unit (APU), a microprocessor, a microcontroller, an application-specific integrated circuit (ASIC) a digital signal processors (DSP), a field-programmable gate array (FPGA), and/or any other suitable type of processing or computing device that can be implemented in the computing device 110.

In some example implementations, the processing device 111 may be capable of being programmed to perform one or more operations described herein. Further, the processing device 111 may include a plurality of processing or computing units, each of which may be dedicated to performing a specific operation. For forms of the processing device 111 with multiple processing units, distributed, pipelined, or parallel processing may be used. The processing device 111 may be dedicated to performing the operations described herein or may be used in one or more additional applications. The processing device 111 may also be of a programmable variety that executes processes and processes data in accordance with programming instructions (such as software or firmware) stored or loaded in the memory device 112. Alternatively or additionally, programming instructions are at least partially defined by hardwired logic or other hardware. The processing device 111 may be comprised of one or more components of any type suitable type to process the signals received from the IO device 113 or elsewhere, and provide desired output based thereon. Such components may include digital circuitry, analog circuitry, or a combination thereof.

The memory device 112 may include one or more storage mediums for storing temporary data, runtime variables, program instructions, and buffers required for the operations of the computing device 110. According to example embodiments, the memory device 112 may include one or more of: a read-only memory (ROM), a random-access memory (RAM), a dynamic or static storage device (e.g., a flash memory, a magnetic memory, and/or an optical memory), and any other suitable type of memory device that can be implemented in the computing device 110 to store or load information and/or instructions for use by the processing device 111.

According to example embodiments, the IO device 113 may be configured to enable the computing device 110 to communicate with the external device 120. For example, the IO device 113 may include a network adapter, a network credential component, a communication interface, and/or a port (e.g., a USB port, serial port, parallel port, an analog port, a digital port, VGA, DVI, HDMI, Fire Wire, CAT 5, Ethernet, fiber, or any other type of port or interface), among other things. The IO device 113 may be comprised of hardware, software, and/or firmware. The IO device 113 may have more than one of the adapters, credentials, interfaces, or ports, such as a first port for receiving data and a second port for transmitting data, among other things.

In some example implementations, the IO device 113 may include an input component and an output component. The input component may enable the computing device 110 to receive information, such as via the external device 120, via user input (e.g., a touch screen display, a keyboard, a keypad, a mouse, a button, a switch, a microphone, etc.), and the like. The output component may provide output information from the computing device 110 (e.g., a display, a speaker, a navigation device, one or more light-emitting diodes (LEDs), etc.).

The storage device 114 may be configured to store non-volatile data, such as firmware, configuration settings, calibration data, information, and/or software related to the operation and use of the computing device 110. For example, the storage device 114 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to example embodiments, the memory device 112 and the storage device 114 may be combined or implemented as a memory storage. In this regard, the memory storage may be of one or more types, such as a solid-state variety, electromagnetic variety, optical variety, or a combination thereof. Furthermore, the memory storage may be volatile, nonvolatile, transitory, non-transitory, or a combination thereof, and some or all of the memory storage may be of a portable variety, such as a disk, tape, memory stick, cartridge, and the like. In addition, the memory storage may store data that may be manipulated or utilized by the processing device 111, such as data representative of signals received from or sent to the IO device 113 in addition to or in lieu of storing programming instructions, among other things. The memory storage may be included with the processing device 111 or communicatively coupled to the processing device 111.

According to embodiments, the memory device 112 and/or the storage device 114 may be configured to store computer-readable instructions, computer-executable instructions, and/or programming codes for implementing one or more operations of the computing device 110. Specifically, the instructions/programming codes may be configured to cause the processing device 111 to perform one or more operations of the computing device 110, when being executed by the processing device 111. The memory device 112 and/or the storage device 114 may provide the stored information for the execution of the processing device 111. Furthermore, the memory device 112 and/or the storage device 114 may store or load data or information that may be utilized by the processing device 111 to perform one or more operations, such as Artificial Intelligence and/or Machine Learning (AI/ML) models, training data, testing/validation data, inference data, visual media or multimodal assets (e.g., images, videos, etc.), user input histories, and the like. Further, the memory device 112 and/or the storage device 114 may be configured to store one or more data involved in the operations of the computing device 110, such as the chatbot responses and visual media outputted by the computing device 110, responses provided by the user, data or information provided by another device (e.g., external device 120, etc.), and the like.

According to example embodiments, computer-executable instructions, computer-readable instructions, and/or computer programming codes (e.g., software instructions, etc.) may be read or loaded into the memory device 112 from the storage device 114, and then be further provided by the memory device 112 to the processing device 111 for execution. Additionally or alternatively, the computer-executable instructions, computer-readable instructions, and/or computer programming codes (e.g., software instructions, etc.) may be read into the memory device 112 and/or storage device 114 from another computer-readable medium or from another device (e.g., external device 120, etc.). When executed, the instructions/codes stored or loaded in memory device 112 and/or storage device 114 may cause the processing device 111 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

According to example embodiments, devices 111 to 114 of the computing device 110 may communicatively couple to and interoperate with each other. For instance, the devices 111 to 114 may be coupled via a bus, router, fiber optic, wire, cable, and the like, which provide a means for data transfer and flow of control signals therebetween. As a non-limiting example, the computing device 110 may further include a bus, such as: an internal bus, an address bus, a data bus, a control bus, a controller area network (CAN) bus, an Ethernet bus, a peripheral component interconnect express (PCIe) bus, and any other suitable type of bus that can be implemented in the computing device 110 to enable communication and coordination between the components within the computing device 110 in real-time, near-real-time, and/or non-real-time.

The external device 120 may include any type of device that may communicatively couple to the computing device 110, and be configured to provide data to and/or receive data from the computing device 110. For instance, the external device 120 may include a user equipment (UE) (e.g., another computing device, etc.) that may be utilized by a user to access the computing device 110 to utilize or manage the multimodal chatbot. As a non-limiting example, the external device 120 may run a client application or web interface through which the associated user accesses and interacts with the multimodal chatbot implemented by the computing device 110.

Additionally or alternatively, the external device 120 may include a database that stores information required by the chatbot to operate, such as AI/ML models, training data, testing/validation data, inference data, visual media/multimodal assets (e.g., images, videos, etc.), user input history, and the like. For instance, the external device 120 may include a database stored on another computer device, a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 120 may be a modular device that can be integrated into the computing device 110.

In view of the above, the computing device 110 may be configured to interoperate with the external device 120 to provide one or more services to a user via the implementation of the multimodal chatbot. According to example embodiments, the computing device 110 may be configured to implement and operate a multimodal chatbot to communicate with a user. In this regard, one or more operations described herein may be performed by the computing device 110 upon implementing a multimodal chatbot. Specifically, descriptions like “the computing device may implement the chatbot to perform an operation” may be interpreted as “the computing device may execute computer-readable instructions or programming codes that operate the chatbot to perform the operation”, and the like.

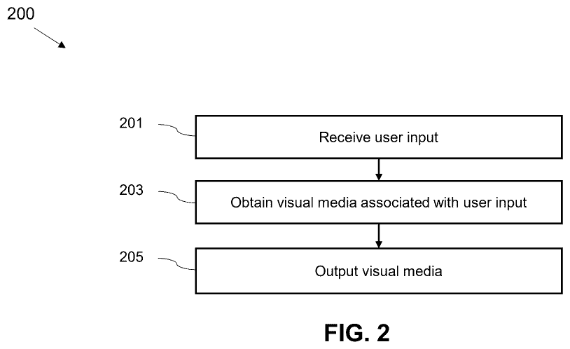

FIG. 2 illustrates an exemplary generic process 200 for operating a multimodal chatbot, according to one or more example embodiments. One or more operations in process 200 may be performed by the computing device 110 via implementing or operating the multimodal chatbot.

As illustrated in FIG. 2, at operation 201, the computing device 110 may be configured to implement the chatbot to receive one or more user inputs. For instance, a user may access the computing device 110 (e.g., access indirectly via the external device 120, access directly via the IO device 113, etc.) and provide a user input(s) thereto, thereby interacting and communicating with the chatbot implemented by the computing device 110. The user input may include, for example, a text, an audio, an image, and/or a video. Further, the user input may define a character or a person. For instance, the user input may include a text that defines a name of a character/person, an audio that describes an appearance or characteristics of the character/person, an image of the character/person, and the like.

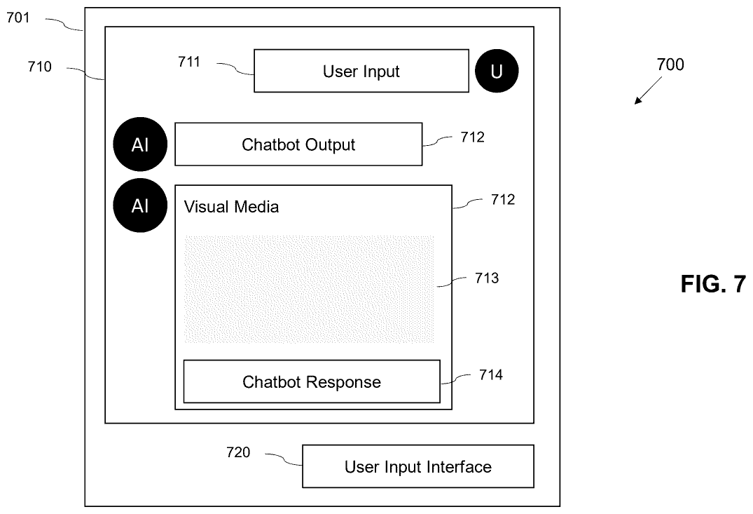

According to example embodiments, when the user accesses the computing device 110 (or the chatbot implemented thereby), the computing device 110 may generate and output a chatbot interface to the user and receive a user input(s) from the user via the chatbot interface. In this regard, the chatbot interface may refer to a user interface (UI) that includes interactive elements (e.g., button, text input field, etc.) that enable the user to interact and communicate with the chatbot, as well as a display section that output and present the communications among the chatbot and the user. According to example embodiments, the chatbot interface may include interactive elements that are multimodal-compatible. For instance, in addition to generic text input fields and buttons that enable the user to communicate with the chatbot via providing text inputs, the chatbot interface may also include components that allow the user to provide various types of inputs, such as a component that suggests and enables the user to provide audio inputs (e.g., a microphone icon, a voice command button, etc.), image inputs (e.g., an image upload button, a drag-and-drop section, etc.), and/or video inputs (e.g., a video upload button, a camera button to capture a video in real-time, etc.). Several examples of the chatbot interface are described below with reference to FIG. 7 to FIG. 11.

Referring still to FIG. 2, upon receiving the user input(s), process 200 may proceed to operation 203, where the computing device 110 may be configured to implement the chatbot to obtain a visual media associated with the user input. In this regard, the visual media may include, for example, an image (e.g., image associated with the user input), a video (e.g., video associated with the user input), and/or an avatar associated with a character or a person (e.g., a character/person defined by the user input).

According to example embodiments, the computing device 110 may implement the chatbot to retrieve the visual media from a database and/or generate the visual media based on the user input. Specifically, upon receiving the user input, the computing device 110 may process and convert the user input into a format that the downstream components or models can understand. For instance, the computing device 110 may convert the user input into a retrieval query for retrieving the associated visual media from the database. Additionally or alternatively, the computing device 110 may convert the user input into instructions for generating the associated visual media. The query or instructions may be presented in the form of embeddings (i.e., numerical or vector representations that reflect or represent the semantic context of the user input). The embeddings may include vector embeddings which may be generated by AI/ML model(s) using vectors of real numbers, among other things. Embedded in a high-dimensional space, these vector embeddings may encapsulate the original data's relationships and characteristics in a format suitable for computation. One benefit of vector embedding is that it allows for capturing and representing the semantic relationships between words or entities in a continuous vector space.

This means similar words or entities are mapped to vectors that are close to each other, enabling more effective processing and understanding of natural language by AI/ML model(s). This facilitates tasks like searching the database, recommendation, and clustering by making it easier to identify and work with related concepts.

According to example embodiments, the computing device may implement the chatbot to generate one or more visual media retrieval queries based on the user input, and then retrieve one or more list(s) of visual media associated with the user input from a database based thereon. Accordingly, the computing device may implement the chatbot to select, from the list(s) of visual media, one or more visual media for outputting to the user, and then output the selected visual media to the user via the chatbot interface.

According to example embodiments, the computing device may implement the chatbot to generate one or more visual media generation instructions based on the user input, and then generate one or more lists of visual media associated with the user input based on the visual media generation instruction. Accordingly, the computing device may implement the chatbot to select, from the list(s) of visual media, one or more visual media for outputting to the user, and then output the selected visual media to the user via the chatbot interface.

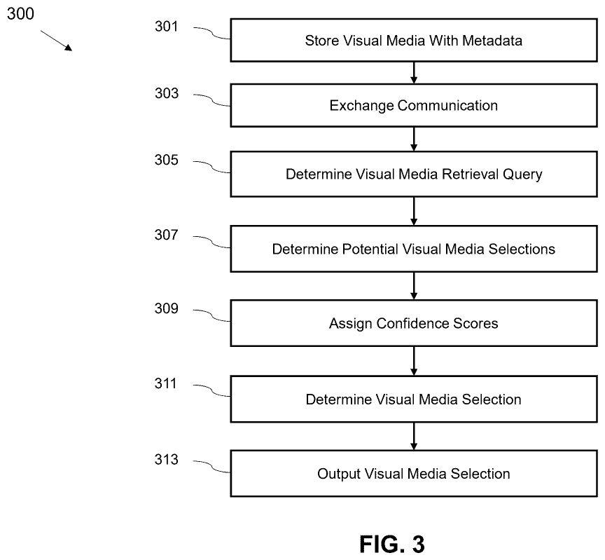

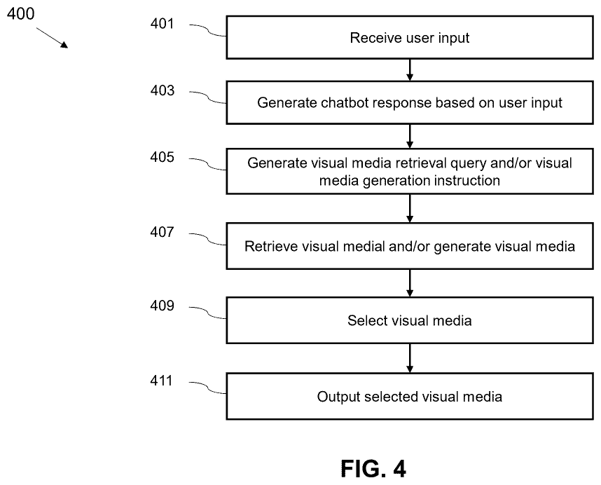

According to example embodiments, the computing device may implement the chatbot to generate both the visual media retrieval query(s) and visual media generation instruction(s). In this case, the computing device may implement the chatbot to retrieve a first list of visual media from a database based on the visual media retrieval query, and generate a second list of visual media based on the visual media generation instructions. Accordingly, the computing device may implement the chatbot to obtain an ensemble of visual media based on the first list and second list of visual media, select at least one visual media from the ensemble of visual media, and output the selected visual media via the chatbot interface. For instance, the computing device may implement the chatbot to select the visual media from the ensemble based on a confidence score of similarity associated with the visual media. Further descriptions associated with the ensemble and confidence score are provided below with reference to FIG. 3 and FIG. 4. It is contemplated that the computing device may implement the chatbot to retrieve more than one list of visual media and/or generate more than one list of visual media, and then select one or more visual media therefrom in a similar manner.

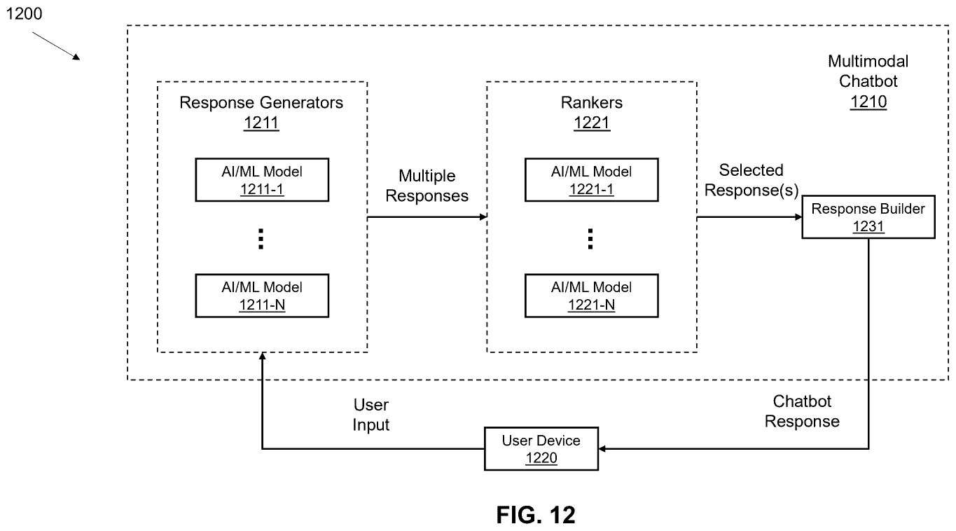

According to example embodiments, the computing device 110 may be configured to utilize one or more AI/ML models to implement or operate the chatbot. For instance, the computing device 110 may utilize a single, unified multimodal AI/ML model that can process and encode various types of user inputs (e.g., text, audio, image, video, etc.) into appropriate embeddings. Additionally or alternatively, the computing device 110 may be configured to utilize multiple AI/ML models, each of which may be optimized for a specific modality (e.g., one of the AI/ML models may be optimized for processing texts, another one of the AI/ML models may be optimized for processing images or videos, etc.). In this case, the computing device 110 may further implement a fusion model (or any other suitable technologies) to combine the outputs of each of the AI/ML models to form one or more unified, comprehensive embeddings that reflect or represent the user input. Further, the computing device 110 may also utilize multiple AI/ML models, each of which may be trained or fine-tuned for a specific operation (e.g., one or more of the AI/ML models may be utilized for processing the user inputs and/or generating responses thereto, one or more of the AI./ML models may be utilized for ranking and selecting one or more responses from the generated responses, etc.). Descriptions of an example implementation of the multimodal chatbot are provided below with reference to FIG. 12.

As a non-limiting list of examples, the AI/ML model(s) may include one or more deep learning models (e.g., convolutional neural networks (CNNs), recurrent neural networks (RNNs), long short-term memory networks (LSTMs), encoder-decoder architectures, attention mechanisms, transformer models, or sequence-to-sequence (seq2seq) models, etc.), reinforcement learning (RL) models (e.g., Q-learning models, a deep Q-network (DQN) models, advantage actor-critic (A2C) model, a proximal policy optimization (PPO) model, etc.), large language models (LLMs) (e.g., bidirectional encoder representations from transformers (BERT) models, generative pre-trained transformer (GPT) models, text-to-text transfer transformer (T5) models, open-source LLMs, proprietary LLMs, instruction-tuned LLMs, conversational LLMs, compact LLMs, continual learning LLMs, domain-specific LLMs, etc.), and/or any other suitable types of AI/ML models. In some example embodiments, one or more of the above-mentioned AI/ML models may be trained, fine-tuned, or optimized for one or more specific tasks. For instance, one or more of the above-mentioned AI/ML models may be optimized for processing a user input received from a user and generate responses based thereon, for ranking and selecting one or more appropriate responses from among the responses generated by another AI/ML model(s), for aggregating the selected responses and building/organizing an appropriate chatbot response for presenting to the user, and the like.

According to example embodiments, in addition to multimodal fusion (which converts different types of user inputs into a unified embedding), the computing device 110 may be configured to implement or operate the chatbot to refine or enhance the user input by, for example, performing retrieval augmented generation (RAG), contextual retrieval operation, query expansion, feedback loops and interactive refinement, and/or any other suitable types of technologies. This may enable the chatbot to generate instructions (e.g., retrieval query, generation instruction, embedding, etc.) that more precisely capture the intent of the user input, which in turn enables the retrieval or generation of visual media that accurately reflects and/or responds to the user input. In some example embodiments, the computing device 110 may be configured to implement or operate the chatbot to refine or enhance the response(s) generated by the chatbot, before presenting the response(s) to the user. For example, the computing device 110 may implement or operate the chatbot to perform RAG, contextual retrieval operation, and the like. As a non-limiting example, the chatbot may extract relevant and/or up-to-date information from one or more databases and enrich the generated response(s), thereby ensuring that the response(s) provided to the user is concise, precise, and up-to-date.

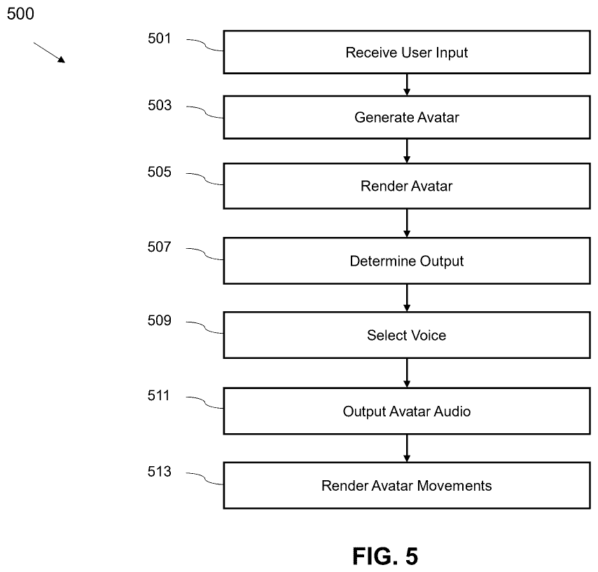

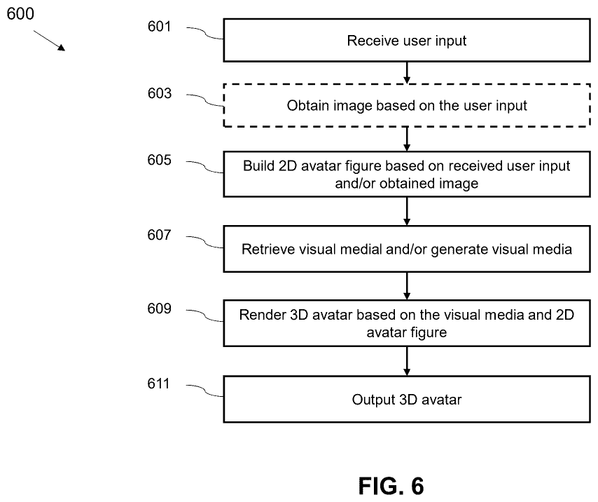

According to example embodiments where the visual media includes the avatar, the computing device 110 may implement the chatbot to generate and output an avatar based on the user input. In this regard, the avatar may include a three-dimensional (3D) avatar that resembles a character or person defined by the user input. For example, the user input may include a text defining or describing a character/person, and thus the computing device 110 may implement the chatbot to obtain an image associated with the character/person (e.g., perform Internet/database search, generate the image via generative AI/ML model, etc.), build an avatar figure (e.g., a two-dimensional (2D) figure) based on the obtained image, obtain a visual media based on the user input (e.g., search for the visual media, generate the visual media, etc.), and render the avatar based on the avatar figure and the visual media. As another example, the user input may include an image or a video (from which an associated image may be obtained) that defines or describes the character/person. In this case, the computing device 110 may implement the chatbot to build the avatar figure based on the image included in the user input, obtain a visual media based on the user input, and render the avatar based on the avatar figure and the visual media. Further descriptions associated with the rendering of the avatar are provided below with reference to FIG. 5 and FIG. 6.

Referring still to FIG. 2, upon obtaining the visual media, process 200 may proceed to operation 205, where the computing device 110 may be configured to implement the chatbot to output the visual media. For instance, the computing device 110 may update the chatbot interface to present or display the obtained visual media. In some example embodiments, the computing device 110 may be configured to output the visual media along with a chatbot response. The chatbot response may include, for example, a text description of the outputted visual media, an answer (in the form of text, audio, etc.) to the user's query, additional or supplemental context of the outputted visual media, and the like. The chatbot response may be displayed at any suitable position (e.g., at the bottom of the chatbot interface, etc.), and may be visually distinguished from the visual media (e.g., the response text may have a shadow in the background, the transparency of the response text and/or shadow may be adjusted by the chatbot to distinguish the text from the visual media, etc.).

According to example embodiments where the visual media includes an avatar, the computing device 110 may be configured to implement the chatbot to render a series of avatar movements in real time (or near real time) via the chatbot interface. The series of avatar movements may include, for example, body movements, lip movements, changes in an avatar gesture, changes in an avatar pose, and/or changes in an avatar facial expression. Accordingly, the computing device 110 may implement the chatbot to create a realistic and engaging avatar that represents a user-intended character/person.

According to example embodiments, the computing device 110 may be configured to continuously, periodically, or iteratively refine or train the chatbot via online/offline learning techniques that adapt the ensemble model (and any associated AI/ML models, if applicable), thereby enabling the chatbot to learn and improved over time. For instance, the computing device 110 may implement a reinforcement learning (RL) framework that continuously or iteratively collects performance metrics of the chatbot, such as user ratings, chat durations, response times, and the like, and uses the performance metrics as the reward to fine-tune or refine the AI/ML models utilized by the chatbot.

In view of the above, the computing device 110 may implement a multimodal chatbot to receive, via the chatbot interface, various types of user input (e.g., text, audio, image, and/or video). In addition, the computing device 110 may implement the multimodal chatbot to output, via the chatbot interface, various types of responses, such as various types of visual media (e.g., an image associated with the user input, a video associated with the user input, and/or an avatar associated with the user input), and/or various types of chatbot responses (e.g., text response, audio response, etc.). The multimodal chatbot may be implemented in various types of computing devices, including consumer electronic devices (e.g., television sets, digital photo albums, etc.) and devices of content platforms (e.g., online media streaming platforms, traditional media platforms, etc.).

Accordingly, by enabling the chatbot to receive and process different types of user inputs (including visual media like images and videos) and to output different types of outputs based thereon, example embodiments provide a chatbot that improves the user's experiences and reduces the user's burden in communicating and interacting with the chatbot, as well as addresses the issues of user intend misinterpretation and low output accuracy, since the user may simply provide the visual media to the chatbot without requiring to describe the visual media as in the related art. Further, by deploying the chatbot across a variety of computing devices (e.g., from consumer electronics like television sets and digital photo albums to content platforms such as online media streaming services), the example embodiments enable a more immersive and interactive user experience. Accordingly, example embodiments not only facilitate more intuitive and contextually accurate responses by leveraging the multimodal chatbot, but also foster deeper engagement and personalization, ultimately bridging the gap between human-like interactions and machine responses.

### Example Processes & Operations

As described above, example embodiments of the present disclosure may provide systems, devices, and the like, that may efficiently and effectively implement a visual media-based multimodal chatbot. Descriptions of several example processes and the associated operations, according to one or more example embodiments, are provided below.

For descriptive purposes, the method and operations may be mainly described as being performed by one or more specific components, although it can be understood that, in actual implementations, another related component(s) may perform similar/related operations, without departing from the scope of the present disclosure. For instance, an operation of a computing device retrieving a visual media from a database may indicate or suggest an operation of the database providing the visual media to the computing device, and the like.

According to example embodiments, one or more operations of a computing device may be performed or initiated upon implementing or operating a multimodal chatbot. For instance, the computing device may include a processor (e.g., processing device 111) and a memory storage (e.g., memory device 112, storage device 114, etc.), wherein the memory storage may include computer-executable instructions or programming codes for implementing the multimodal chatbot. The instructions or codes may, when being executed by the processor, cause the processor to perform one or more operations of the chatbot described herein.

### Example Processes & Operations: Chatting with Multimodal Chatbot With Visual Media

As described above, according to example embodiments, a computing device may implement and operate a chatbot to communicate with a user via a visual media, such as images and videos. For instance, the user may provide user inputs to the chatbot via a chatbot interface, and the chatbot may provide a response to the user via the chatbot interface, along with images and videos. The chatbot may be a multimodal chatbot that has the capability to process various types of user input, such as texts, audio, images, videos, and the like. Descriptions of several example embodiments associated therewith are provided below with reference to FIG. 3 to FIG. 4. It is contemplated that one or more operations and example use cases described herein may be implemented by a computing device (e.g., computing device 110), when the computing device implements or operates a multimodal chatbot.

FIG. 3 illustrates a first exemplary process 300 for operating a multimodal chatbot to communicate with a user via a visual media, according to one or more example embodiments. Specifically, process 300 illustrates an example use case where the computing device implements a multimodal chatbot to retrieve and output a stored visual media, in response to a user input. Process 300 may be implemented in whole or in part in one or more computing devices. In certain forms, the functionalities may be performed by separate devices. In certain forms, all functionalities may be performed by the same device. It shall be further appreciated that a number of variations and modifications to the process 300 are contemplated, including, for example, the omission of one or more aspects of the process 300, the addition of further conditionals and operations, or the reorganization or separation of operations and conditionals into separate processes. Further, one or more operations of the process 300 may be similar to or be part of one or more operations of the process 200 in FIG. 2.

The process 300 begins with operation 301, where the computing device may be configured to store visual media, along with the associated metadata, in a database (e.g., external device 120, storage device 114, etc.). The visual media may include images and/or videos. Each visual media stored in the database may have corresponding metadata configured to describe attributes of the visual media and facilitate a search of the database. The metadata may include, among other things, file information (e.g., filename, file format, file size, date created, date modified, etc.), technical metadata (e.g., dimensions, color space, bitrate, frame rate for videos, the duration for videos, codec, etc.), content descriptors (e.g., title, description or caption, keywords or tags, category or genre, etc.), creation details (e.g., camera or equipment used, settings used during capture, location, creator or author's name, etc.), rights and licensing (e.g., copyright holder, usage rights, license information, etc.), descriptive tags (e.g., people present, activities depicted, objects identified, landmarks, text captured, etc.), processing metadata (e.g., software/hardware involved in processing the visual media, date of last edit, version history, etc.), and/or analytical metadata (e.g., sentiment detected, scene categorization, annotations, confidence scores of detected features, etc.). In some example embodiments, the metadata is organized in the form of a vector embedding, which may be numerical representations of complex, non-numerical data. In some example embodiments, the vectors are comprised of real numbers.

At operation 303, the computing device may implement the chatbot to exchange communications with the user. The communications between the user and the chatbot may be performed using text, audio, image, and/or video. According to example embodiments, the computing device may, upon implementing the chatbot, output and display a chatbot interface to communicate with the user. In some example implementations, operation 303 may be automatically triggered when the computing device receives a user input (or an indication that a user has accessed the computing device/chatbot). At this operation, the computing device may be configured to receive a user input via the chatbot interface. The user input may include a text, an audio, an image, and/or a video. Operation 303 may be similar or be part of operation S201 of the process 200.

Upon receiving user input, the computing device may implement the chatbot to determine and output one or more chatbot responses based on the user input. The response(s) may include, for example, a reply to a query associated with the user input, a request for additional information from the user, and the like. The chatbot may leverage prior information (e.g., previous user inputs, conversation histories, previous chatbot responses, etc.) to generate and provide context-aware response(s). In some example embodiments, the chatbot may leverage multimodal capability to provide a response(s) that includes a combination of texts, audio, images, and/or videos. In this regard, whenever the chatbot (or the computing device that implements the chatbot) determines that the response(s) include a visual media, the process 300 may further proceed to operations 305-313 described below.

At operation 305, the computing device may implement the chatbot to determine a visual media retrieval query for searching the database of stored visual media and retrieving the associated visual media therefrom. The visual media retrieval query may be configured to identify visual media with characteristics related to the chatbot conversation. In some example embodiments, the visual media retrieval query may be a function of the embedded vectors corresponding to the user input (and chatbot response(s), if applicable). In some example embodiments, the computing device may implement the chatbot to determine multiple visual media retrieval queries, such as a query for searching stored images and another query for searching stored videos.

According to example embodiments, the computing device may implement the chatbot to determine the visual media query with deep neural networks that use embedded vectors for searching the database. For example, the chatbot may use, among other things, Siamese networks, BERT, sentence transformers (e.g., sentence-BERT), deep structured semantic models (DSSM), deep convolutional neural networks (CNNs) for image retrieval, variational autoencoders (VAEs), neural collaborative filtering (NCF), and/or recurrent neural networks (RNNs), for sequence embeddings.

Upon determining the visual media retrieval query, the process 300 proceeds to operation 307, where the computing device may be configured to implement the chatbot to determine potential visual media selections using the results of querying the databases with the queries determines in operation 305. In some example embodiments, the potential visual media selections may include an image stored in the database, a video stored in the database, or an aggregation of images and/or videos stored in the database.

In some example embodiments, the potential visual media selections may be determined using cosine similarity to compare the embedded vectors of the stored visual media and the embedded vectors of the visual media retrieval query. Cosine similarity may be calculated by taking the dot product of the vectors and dividing that by the product of their magnitudes (or Euclidean norms), which effectively measures the cosine of the angle between the two vectors. For example, a cosine value of 1 indicates that the vectors are identical in orientation, 0 indicates orthogonality (no similarity), and −1 indicates they are diametrically opposed.

In some example embodiments, one or more images and/or videos of the database may be used as input for a deep learning model to generate a potential visual media selection. For example, the deep learning model may include one or more generative adversarial networks (GANs), VAEs, RNNs, LSTM networks, 3D CNNs, transformer models, or auto-regressive models, among other things. In this way, the chatbot may facilitate automatic image and/or video generation with a chat function for interactively developing the image, video, and story over time.

After determining the potential visual media selections, the process 300 may proceed to operation 309, where the computing device may be configured to implement the chatbot to assign confidence scores to the potential visual media selections. In this regard, a confidence score may indicate the likelihood the associated potential visual media selection is relevant to the chatbot conversation (e.g., the user input, the chatbot response, etc.). According to example embodiments, the computing device may implement the chatbot to assign confidence scores as a function of the visual media retrieval query and the metadata, such as the embedded vectors, corresponding to stored visual media.

In some example embodiments, the computing device may implement the chatbot to compare a real number embedded vector of the visual media retrieval query and the real number embedded vectors of the stored visual media. For example, the chatbot (or the computing device) may determine the embedding distance between the embedded vectors of the visual media and the embedded vector of the visual media retrieval query. Embedding distance may refer to a measure of similarity or dissimilarity between two data points after they have been transformed into a high-dimensional space known as an embedding space. The embedded vector is a representation of a data point in a continuous vector space. For example, words can be represented as vectors (word embeddings) such that words with similar meanings have vectors that are close to each other in this space. If a user input is transformed into an embedding vector, the chatbot might calculate the embedding distance between this input and various stored responses, or between the input and the stored visual media. The response/visual media with the smallest distance (i.e., the most similar embedding) would indicate the highest similarity, and thus receive the highest confidence score.

The potential visual media selections may be ordered (by the computing device or the chatbot) based on the size of the calculated distance and then be assigned values based on weights or a machine learning algorithm, among other things. For example, a stored video with the smallest embedding distance to the visual media retrieval query will receive the highest confidence score.

In some example embodiments, the confidence score may be determined using an ensemble model to consider multiple factors. For example, the potential visual media selection may include an image selected using a visual media retrieval query for images, a video selected using a visual media retrieval query for videos, and a generated video. To select from all the potential options, the ensemble model may use weights to weigh each calculated distance or use an AI/ML model. These weights or AI/ML model may be updated/retrained based on conversation characteristics, such as feedback from the user, the chat duration, or the response time of the user during the chat, among other things.

After assigning the confidence scores, the process 300 may proceed to operation 311, where the computing device may be configured to implement the chatbot to determine the visual media selection for displaying to the user. For instance, the computing device may be configured to implement the chatbot to choose the visual media selection(s) based on the high confidence score, based on whether a confidence score exceeds a threshold, and the like. Operations 305 to 311 as described above may be part of operation 203 in process 200.

Upon determining the visual media selection, the process 300 proceeds to operation 313, where the computing device may be configured to implement the chatbot to output the visual media selection (i.e., the selected visual media). For instance, the computing device may implement the chatbot to generate/update a chatbot interface and output the selected visual media thereon. The visual media may appear in 2D and/or 3D. Operation 313 may be similar to or part of operation 205 in process 200.

In some example embodiments, the computing device may be configured to implement the chatbot to output the visual media, with/without a corresponding chatbot response. The visual media may include the visual media selection determined in operation 311. As noted above, the visual media selection may include one or more images and/or videos. The chatbot interface may also output sound corresponding to the visual media. In some example embodiments where the visual media is outputted along with the corresponding chatbot response, the corresponding chatbot response may overlap with the visual media in the chatbot interface. To distinguish the chatbot response from the visual media, the computing device may implement the chatbot to adjust an appearance characteristic of the chatbot response. For example, the appearance characteristic adjustment may include a change of color of the chatbot response, the addition of an opaque or transparent shadow to the chatbot response, and the like.

In some example embodiments, the chatbot response may be based on the metadata of the selected visual media, the content of the selected visual media, the conversation history, and/or the visual media retrieval query, among other things. The chatbot response may be generated using deep learning models, such as CNNs, RNNs, LSTM networks, encoder-decoder architectures, attention mechanisms, transformer models, and/or seq2seq models, among other things.

Referring next to FIG. 4, which illustrates a second exemplary process 400 for operating a multimodal chatbot to communicate with a user via a visual media, according to one or more example embodiment. Specifically, process 400 illustrates an example use case where the computing device implements a multimodal chatbot to retrieve a stored visual media and/or generate a visual media, in response to a user input. One or more operations in process 400 may be similar to or be part of one or more operations in process 200 and process 300. In this regard, it is contemplated that one or more operations in process 400 may be performed together with one or more operations in process 200 and process 300 in any suitable sequential manner.

According to example embodiments, process 400 may be implemented to facilitate the automatic visual media (e.g., image, video, etc.) generation with a communication or interaction (e.g., chat, etc.) among the user and the chatbot for interactively developing the visual media (e.g., image and/or video scenes, story, etc.) over the time. Accordingly, process 400 may enable the generation of personalized visual media based on the user input (e.g., voice command, text input, image/video upload, etc.).

The process 400 may be implemented in whole or in part in one or more computing devices. In certain forms, the functionalities may be performed by separate devices. In certain forms, all functionalities may be performed by the same device. It shall be further appreciated that a number of variations and modifications to the process 400 are contemplated, including, for example, the omission of one or more aspects of the process 400, the addition of further conditionals and operations, or the reorganization or separation of operations and conditionals into separate processes.

The process 400 begins with operation 401, where the computing device may be configured to implement the chatbot to receive a user input from a user. As described above, the computing device may implement the chatbot to receive the user input from the user via a chatbot interface, while the user input may include a text, an audio, an image, and/or a video. Operation 401 may be similar to operation 201 in process 200 and operation 303 in process 300. Thus, further descriptions associated therewith may be omitted below for conciseness.

Upon receiving the user input, process 400 may proceed to operation 403, where the computing device may be configured to generate a chatbot response based on the user input. In some example embodiments, the chatbot response may be generated based on the user input and the context of previous communication (e.g., previous user inputs, previous chatbot responses, etc.).

Upon generating the chatbot responses, process 400 may proceed to operation 405, where the computing device may be configured to implement the chatbot to generate a visual media retrieval query and/or a visual media generation instruction. Specifically, the computing device may be configured to implement the chatbot to embed the user input and the chatbot response into real number vectors (e.g., via text embedding technique), and generate the visual media retrieval query and/or the visual media generation instruction based thereon. For instance, once the user input and the chatbot response are converted into embeddings, the computing device may implement the chatbot to aggregate the embeddings (e.g., via concatenating, averaging, attention-based fusion, etc.) to create a unified embedding that encompasses the intent and context of the embeddings. In some example embodiments, the computing device may implement the chatbot to further refine or enhance the unified embedding by, for example, performing retrieval augmented generation (RAG), contextual retrieval operation, query expansion, feedback loops and interactive refinement, and/or any other suitable types of technologies. Subsequently, the computing device may utilize the unified embedding to search visual media (e.g., images/videos embedded into real number vectors using image and/or video embedding algorithms) stored in a database. Additionally or alternatively, the computing device may decode the unified embedding into a natural language prompt that serves as an instruction for an image and/or video generative model (e.g., GAN model, diffusion model, etc.).

Upon generating the visual medial retrieval query and/or the visual media generation instruction, process 400 may proceed to operation 407, where the computing device may be configured to implement the chatbot to retrieve the associated visual medial and/or generate the associated visual media. In some example implementations, the computing device may utilize one or more AI/ML technologies, such as deep neural networks, to perform the visual media retrieval and/or generation tasks.

According to example embodiments where the computing device has generated the visual media retrieval query (which includes the unified embedding or a combined representation of the user input and the chatbot response), the computing device may implement the chatbot to compare the unified embedding (or the combined representation) in the visual media retrieval query against embeddings of the visual media stored in the database, based on a similarity metric (e.g., cosine similarity, etc.). The similarity metric may define how close the vectors or the embeddings are in the semantic space, i.e., defining which visual media are the most related to the unified embedding (that represents the user input and the chatbot response). Accordingly, based on the similarity metric, the computing device may implement the chatbot to retrieve relevant visual media from the database.

According to example embodiments where the computing device has generated the visual media generation instruction (which includes a natural language prompt), the computing device may implement the chatbot to input the instruction (or the natural language prompt included therein) to one or more image/video generative models, thereby obtaining the relevant visual media as the outputs of the one or more generative models.

In this regard, the results from the visual media retrieval and/or generation processes may form a list of candidate visual media that are relevant to the user input and the chatbot response. Each candidate visual media may be assigned a confidence score that reflects how well the visual media's embedding matches the unified embedding that represents the user input and chatbot response. Each confidence score may be computed based on the distance between the embeddings of the visual media and the unified embedding (that represents the user input and the chatbot response) included in the visual media retrieval query and/or visual media generation instruction. For instance, lower cosine distances (i.e., higher cosine similarities) may indicate a stronger match between the content of the candidate visual media and the semantic context of the user input and the chatbot response.

According to example embodiments, the computing device may implement the chatbot to apply an ensemble approach to integrate the visual media obtained via different approaches (e.g., visual media obtained via image query, video query, image generation, and/or video generation). For instance, the computing device may implement the chatbot to obtain an ensemble of visual media, based on the list of visual media retrieved from the database and the list of visual media generated based on the user input. The ensemble may be implemented as a weighted linear combination (e.g., the confidence score of each candidate visual media may be multiplied by a predetermined weight) or as a neural network model (e.g., the confidence score of each candidate visual media may be combined or processed).

Subsequently, at operation 409, the computing device may be configured to implement the chatbot to select one or more visual media for displaying to the user. For instance, the computing device may be configured to implement the chatbot to select the visual media based on the associated confidence score (e.g., visual media that has the highest confidence score may be selected, multiple visual media of which the associated confidence scores exceed a predefined threshold may be selected, etc.). Operations 403 to 409 as described above may be part of operation 203 in process 200 or may involve one or more of operations 305 to 311 in process 300.

Upon selecting the visual media, process 400 may proceed to operation 411, where the computing device may be configured to implement the chatbot to output the selected visual media. For instance, the computing device may implement the chatbot to output the selected visual media on the chatbot interface, with/without the chatbot response presented at the bottom (or any other suitable position) of the chatbot interface. The chatbot response may be adjusted to be distinguished from the visual media (e.g., the text of the chatbot response may have a shadow in the background to distinguish it from the text of the visual media, etc.). Operation 411 may be similar to operation 205 in process 200 or operation 313 in process 300, thus further descriptions associated therewith may be omitted below for conciseness.

It is contemplated that the processes and operations described above with reference to FIG. 3 and FIG. 4 are merely examples, and the scope of the present disclosure should not be limited thereto. Specifically, the processes may include more/less operations, the operations may be performed in a different manner, and the like, without departing from the scope of the present disclosure. For instance, when implementing process 400, the computing device may implement the chatbot to only retrieve visual media stored in a database or only generate visual media. In this case, the computing device may implement the chatbot to perform only a part of the operations in process 400. Further, one or more operations in one or more of FIG. 3 and FIG. 4 may be implemented by the computing device via utilizing multiple AI/ML models, each of which may be trained, fine-tuned, or optimized for performing a specific operation. For instance, the computing device may utilize a first AI/ML model(s) to implement a first operation(s) in FIG. 3 and a second AI/ML model(s) to implement a second operation(s) in FIG. 3, and the like. Further descriptions of an example implementation of the multimodal chatbot are provided below with reference to FIG. 12.

### Example Processes & Operations: Personalized Avatar Design With Multimodal Chatbot

As described above, according to example embodiments, a computing device may implement and operate a multimodal chatbot to design and display a personalized avatar. For instance, the user may provide user inputs that define a character or a person, and the chatbot may design and output an avatar that resembles the user-defined character/person on the chatbot interface. The chatbot may be a multimodal chatbot that has the capability to process various types of user input, such as texts, audio, images, videos, and the like. Descriptions of several example embodiments associated therewith are provided below with reference to FIG. 5 to FIG. 6. It is contemplated that one or more operations and example use cases described herein may be implemented by a computing device (e.g., computing device 110), when the computing device implements or operates a chatbot.

FIG. 5 illustrates a first exemplary process 500 for operating a multimodal chatbot to display a personalized avatar, according to one or more example embodiments. Specifically, process 500 illustrates an example use case where the computing device implements a multimodal chatbot to render a personalized avatar, in response to a user input. The process 500 may be implemented in whole or in part in one or more computing devices. In certain forms, the functionalities may be performed by separate devices. In certain forms, all functionalities may be performed by the same device. It shall be further appreciated that a number of variations and modifications to the process 500 are contemplated, including, for example, the omission of one or more aspects of the process 500, the addition of further conditionals and operations, or the reorganization or separation of operations and conditionals into separate processes. Further, one or more operations of the process 500 may be similar to or part of one or more operations of the process 200 in FIG. 2, and may be performed along with one or more operations of the process 300 in FIG. 3 or process 400 in FIG. 4.

The process 500 begins with operation 501, where the computing device may be configured to implement the chatbot to receive a user input from the user. For instance, the computing device may implement the chatbot to receive the user input from the user via a chatbot interface. This operation may be similar to operation 201 in process 200, operation 303 in process 300, and/or operation 401 in process 400. Thus, redundant descriptions associated therewith may be omitted below for conciseness.

According to example embodiments, the user input may include various types of inputs, such as text, audio, image, and/or video, among other things. The user input may describe or define a character or a person. For instance, the user input may associate or define a name of a character/person, a description of a user-intended appearance/characteristic of the character/person, an image of the character/person, a video showing a movement or gesture of the character/person, and the like.

Upon receiving the user input, process 500 may proceed to operation 503, where the computing device may be configured to implement the chatbot to generate an avatar based on the user input. According to example embodiments where the user input includes an image or a video (from which an image may be obtained) that defines the character/person, the computing device may implement the chatbot to generate the avatar based on the image. According to example embodiments where the user input includes a text or audio that defines the character/person, the computing device may implement the chatbot to obtain an image using the user input. For instance, the computing device may implement the chatbot to generate the image and/or search the image. The search may be conducted, among other things, by way of an internet search engine or a database query.

According to example embodiments, the computing device may implement the chatbot to generate a two-dimensional (2D) and/or a three-dimensional (3D) avatar. In this regard, the computing device may implement the chatbot to generate the avatar using, among other things, photogrammetry, structure from motion (SFM), multi-view stereo (MVS), volumetric reconstruction, neural networks/deep learning, space carving, depth map estimation, and/or single image 3D reconstruction.

Upon generating the avatar, the process 500 may proceed to operation 505, where the computing device may be configured to implement the chatbot to render the avatar. For instance, the avatar may be rendered in 2D or 3D on the chatbot interface. In some example embodiments, the computing device may implement the chatbot to render the avatar by integrating the avatar into a virtual or augmented reality environment, allowing the avatar to interact with the user in real-time (or near-real-time).

Upon rendering the avatar, the process 500 may proceed to operation 507, wherein the computing device may be configured to implement the chatbot to determine an output (e.g., a verbal output, etc.). In some example embodiments, the output may include a content violation notification which communicates that the input to the chatbot from the user has violated a rule. In some example embodiments, the output may include another type of notification determined in response to the user input. According to example embodiments, the computing device may implement the chatbot to determine the output using, among other things, rule-based responses, template-based responses, retrieval-based models, generative models, hybrid models, contextual and memory-based models, reinforcement learning, knowledge-based models, natural language understanding (NLU) enhanced models, and/or sentiment analysis-based responses.

Upon determining the output, the process 500 may proceed to operation 509, where the computing device may be configured to implement the chatbot to select a synthesized voice for outputting a speech along with the avatar. In some example embodiments, the voice is selected based on the avatar. For example, the voice may be selected based on an age or gender characteristic of the avatar, such as selecting a voice corresponding to a man, a woman, a well-known character/person, and the like. In some example embodiments, the characteristic is a personality type, an expression type, a nationality type, and the like. In some example embodiments, the user may upload an audio recording of the character/person and the computing device may implement the chatbot to synthesize a voice using, among other things, speech signal processing and feature extraction, mel-frequency cepstral coefficients (MFCCs), linear predictive coding (LPC), deep learning models (e.g., CNNs, RNNs), voiceprint recognition (e.g., speaker identification, etc.), formant analysis, pitch analysis, spectrogram analysis, phoneme-based profiling, prosody analysis, vocal tract length normalization (VTLN), gaussian mixture models (GMMs), i-vectors and x-vectors, wavelet transform, and/or voice biometrics systems.

After the synthesized voice is selected and the verbal output is determined, the process 500 may proceed to operations 511 and 513, where the computing device may be configured to output the determined output and the associated avatar via the chatbot interface, and simultaneously render a series of avatar movements. The series of avatar movements may include body movement, gestures, facial expressions, poses, and/or lip movements, which are rendered in response to the user input. The pose of the avatar may also be changed based on the context of the conversation. In some example embodiments, the lip movements are synchronized to the avatar audio output to appear as if the avatar is speaking the words of the avatar audio output. The lips may be synchronized to the audio using, among other things, DeepFaceLab, Adobe Character Animator, NVIDIA Omniverse Audio2Face, viseme-based animation systems, Faceware Studio, JALI (joint audio-text driven facial animation), Microsoft Azure Speech API with lip sync, Canny AI's VDub (video dub), Speech Graphics, and/or Reallusion iClone lip sync animation. In this regard, as the computing device implements the chatbot to output the avatar and the associated voice to communicate with the user, the chatbot may update or render the avatar to adjust the avatar (e.g., change the orientation or pose of the avatar, sync the lip movement of the avatar, adjust the expression of the avatar, etc.) based on the context of the conversation.

FIG. 6 shows a second exemplary process 600 for operating a chatbot to display a personalized avatar, in accordance with an example embodiment. Specifically, process 600 illustrates an example use case where the computing device implements a multimodal chatbot to build a 2D avatar figure and then render a 3D avatar based on the 2D avatar figure, in response to a user input. As further described below, according to example embodiments, process 600 may be implemented to build a 2D avatar figure with multimodal input processing, followed by visual media enhancement via visual media retrieval and/or generation, and rendering a 3D avatar based on the 2D avatar figure and the visual media, thereby delivering a personalized, visually enriched avatar that interacts with the user.

The process 600 may be implemented in whole or in part in one or more computing devices. In certain forms, the functionalities may be performed by separate devices. In certain forms, all functionalities may be performed by the same device. It shall be further appreciated that a number of variations and modifications to the process 600 are contemplated, including, for example, the omission of one or more aspects of the process 600, the addition of further conditionals and operations, or the reorganization or separation of operations and conditionals into separate processes. Further, one or more operations of the process 600 may be similar to or part of one or more operations of the process 200 in FIG. 2, and may be performed along with one or more operations of the process 300 in FIG. 3, process 400 in FIG. 4, and/or process 500 in FIG. 5, in any suitable sequential manner.

The process 600 begins with operation 601, where the computing device may be configured to implement the chatbot to receive a user input from a user. For instance, the user input may be received via a chatbot interface. The user input may include a text, audio, image, and/or video associated with a character or person. Operation 601 may be similar to operation 501 in process 500, thus further descriptions associated therewith may be omitted below for conciseness.

Upon receiving the user input, process 600 may proceed to optional operation 603 or operation 605. Specifically, optional operation 603 may be triggered when the user input does not contain an image associated with the character/person. Alternatively or additionally, operation 603 may be triggered when the computing device determines that additional image(s) is required for building a 2D avatar figure (e.g., the image included in the user input is insufficient, additional image(s) is required to enhance or enrich the image included in the user input, etc.).

At optional operation 603, the computing device may be configured to implement the chatbot to obtain an image associated with the character/person. For instance, the computing device may implement the chatbot to search (e.g., by way of an internet search engine, a database query, etc.) for an image associated with the character/person, and/or generate the image based on the user input. The operations of retrieving and/or generating images may be similar to those described above with reference to process 400 in FIG. 4, thus further descriptions associated therewith may be omitted below for conciseness.

At operation 605, the computing device may be configured to implement the chatbot to build one or more 2D avatar figures that resemble the character/person defined by the user input. For instance, the computing device may implement the chatbot to generate the 2D avatar figure(s) based on the text descriptions included in the user input, perform image processing on the image(s) included in the user input and/or image(s) obtained at operation 603, and the like. According to example embodiments, the computing device may utilize multimodal AI/ML models to extract salient features and characteristics (e.g., facial expression, gender, age, nationality, stylistic presentation, descriptive details, etc.) from the images and/or user input, and then synthesize or present the features/characteristics in a 2D figure that resembles the user-defined character/person.

Upon building the 2D avatar figure(s), the process 600 may proceed to operation 607, where the computing device may be configured to implement the chatbot to retrieve and/or generate one or more visual media associated with the character/person defined in the user input. The visual media may supplement or enrich the design of the avatar. For instance, the visual media may include: an image of the character/person from a different perspective or view angle, an image of the character/perform with a different pose or facial expression, a video showing a movement of the character/person, an audio of the voice of the character/person, and the like. The operations for retrieving and/or generating visual media may be similar with those described above with reference to at least process 400 in FIG. 4, thus further descriptions associated therewith may be omitted below for conciseness.

Upon obtaining the visual media, process 600 may proceed to operation 609, where the computing device may be configured to implement the chatbot to render a 3D avatar based on the 2D avatar figure and the obtained visual media. For instance, the computing device may implement the chatbot to transform the 2D avatar figure into a fully rendered 3D avatar. The rendering operation may involve any suitable 2D- to-3D conversion technologies, such as depth estimation, neural radiance fields (NeRF), and the like. The resulting 3D avatar not only captures or reflects the characteristics and design details of the 2D avatar figure, but may also integrate dynamic interactive elements (e.g., animations or movements of the 3D avatar, lip shape changes that synchronize with a voice/speech of the avatar, expression changes according to the context of the conversation among the chatbot and the user, etc.), thereby offering a more engaging and lifelike user experience.

Upon rendering the 3D avatar, process 600 may proceed to operation 611, where the computing device may be configured to implement the chatbot to output the 3D avatar. For instance, the computing device may implement the chatbot to output the 3D avatar on the chatbot interface. In some example embodiments, the computing device may implement the chatbot to output the 3D avatar along with a chatbot response (e.g., a text/audio that responds to the user input, a visual media that is associated with the user input, etc.).

It is contemplated that the processes and operations described above with reference to FIG. 5 and FIG. 6 are merely examples, and the scope of the present disclosure should not be limited thereto. Specifically, the processes may include more/less operations, the operations may be performed in a different manner, and the like, without departing from the scope of the present disclosure. For instance, when implementing process 600, the computing device may also implement the chatbot to perform operations 509 to 513 of process 500, such that the 3D avatar may be outputted along with an associated audio and/or movement. Further, one or more operations in one or more of FIG. 5 and FIG. 6 may be implemented by the computing device via utilizing multiple AI/ML models, each of which may be trained, fine-tuned, or optimized for performing a specific operation. For instance, the computing device may utilize a first AI/ML model(s) to implement a first operation(s) in FIG. 5 and a second AI/ML model(s) to implement a second operation(s) in FIG. 5, and the like. Further descriptions of an example implementation of the multimodal chatbot are provided below with reference to FIG. 12.

### Example Embodiments: Chatbot Interface

As described above, according to example embodiments, the computing device may be configured to implement a multimodal chatbot to communicate or interact with a user, via a chatbot interface. Several examples of chatbot interfaces are described below with reference to FIG. 7 to FIG. 11. It is contemplated that some of the example chatbot interfaces described herein may, but not necessarily, include similar components, functionalities, and the like.

FIG. 7 illustrates a first example chatbot interface 700, according to one or more example embodiments. The chatbot interface 700 may be utilized or involved in one or more operations of process 200 in FIG. 2, process 300 in FIG. 3, and/or process 400 in FIG. 4. As illustrated in FIG. 7, the chatbot interface 700 may be presented or outputted on a screen (or a display) 701, and may include a conversation history section 710 and a user input interface 720.

The conversation history section 710 may be configured to display communications between the user and the chatbot. As illustrated, the user input 711 may be presented at the left side of the section 710 along with a user icon (illustrated with a letter “U” in FIG. 7), while the output (or response) 712 of the chatbot may be presented at the right side of the section 710 along with a chatbot icon (illustrated with a term “Al” in FIG. 7). In the example use case of FIG. 7, the user has provided a user input 711 and the chatbot has responded with two chatbot outputs 712, one of which may include at least one visual media 713 (e.g., an image, a video, etc.) and a chatbot response 714. It is contemplated that the section 710 may also be configured to display the communications between the user and the chatbot in any other suitable manner, without departing from the scope of the present disclosure.

The user input interface 720 may be configured to receive input from the user. Specifically, the user input interface 720 may be interactable by the user and enable to user to provide one or more user inputs therefrom. According to example embodiments, the user input interface 720 may include a variety of interactive components to support different types of user inputs. For instance, the user input interface 720 may include a text field that allows the user to provide queries or commands in text form, an audio button that triggers on-the-fly audio recording to record a voice from the user, an upload button that enables the user to upload various types of materials (e.g., text files, audio files, images, videos, etc.), a camera button that triggers on-the-fly image or video capturing, a drag-and-drop area that allows the user to upload materials by dragging and dropping the materials thereto, a search button that enables the user to instruct the chatbot to perform a search (e.g., Internet search, database search, etc.), a drop-down list that allows the user to select one or more AI/ML models that the chatbot can utilize for processing the user input, and the like.

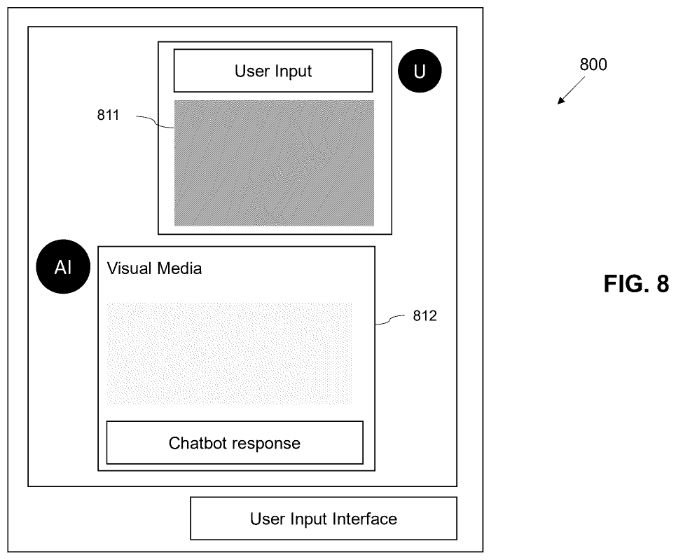

FIG. 8 illustrates a second example chatbot interface 800, according to one or more example embodiments. Chatbot interface 800 may include components (e.g., conversation history section, user input interface, etc.) similar to those described above with reference to FIG. 7. Similarly, the chatbot interface 800 may be utilized or involved in one or more operations of process 200 in FIG. 2, process 300 in FIG. 3, and/or process 400 in FIG. 4.

In the example use case of FIG. 8, the user input includes a visual media 811, such as an image, a video, a plurality of images, a plurality of videos, or a combination thereof. Accordingly, the chatbot may process the user input, generate a response based thereon, obtain visual media (e.g., image, video, etc.) associated therewith, and provide an output 812 that includes the response and the associated visual media on the chatbot interface 800.

As a non-limiting example, a user interested in designing or decorating a room may upload an image of the room and provide a user input (e.g., in text form, audio form, etc.) to insert a furniture into the image (e.g., “Please insert a sofa to the room”), via the chatbot interface 800. In response, the chatbot may output an image of the room with a furniture (e.g., a sofa, etc.) inserted therein, along with a chatbot response (e.g., in text form, audio form, etc.) that answers to the user's request and justifies the visual media (e.g., “Based on the room layout and your interest in Asian style interior design, I have inserted the most popular Asian-style sofa of year 2025. I have placed the sofa as illustrated to enhance the natural light in the room.”, etc.).

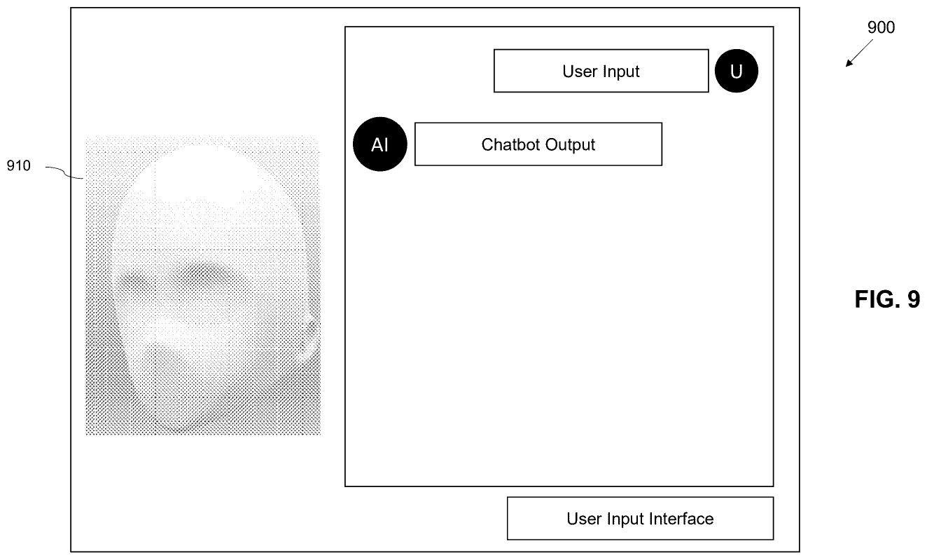

FIG. 9 illustrates a third example chatbot interface 900, according to one or more example embodiments. The chatbot interface 900 may be utilized or involved in one or more operations of process 200 in FIG. 2, process 500 in FIG. 5, and/or process 600 in FIG. 6. Chatbot interface 900 may include components (e.g., conversation history section, user input interface, etc.) similar to those described above with reference to FIG. 7.

In addition, chatbot interface 900 may include an avatar 910. In this regard, the avatar 910 may be generated based on the user input and may resemble a character/person that is defined in the user input (e.g., a text, an audio, etc.). The chatbot may continuously update the avatar 910 in the chatbot interface 900 such that a series of avatar movements may be presented to the user via the chatbot interface 900, along with the chatbot output (and audio, if applicable). For instance, the avatar 910 may be continuously updated to present a movement, gesture, facial expression, pose, lip movement, and the like, that resembles an actual character/person that is defined by the user input and the context of the chatbot output.

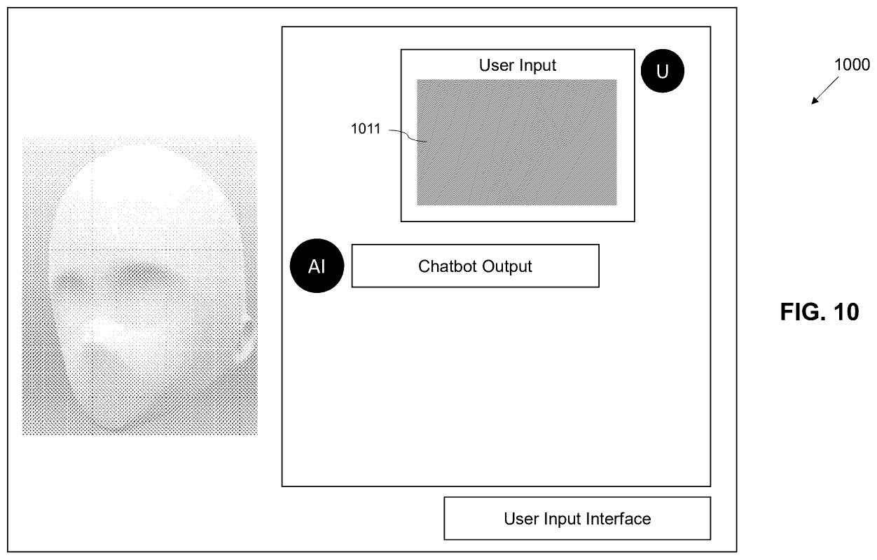

FIG. 10 illustrates a fourth example chatbot interface 1000, according to one or more example embodiments. The chatbot interface 1000 may be utilized or involved in one or more operations of process 200 in FIG. 2, process 500 in FIG. 5, and/or process 600 in FIG. 6. Chatbot interface 1000 may include components (e.g., conversation history section, user input interface, etc.) similar to those described above with reference to FIG. 9.

The example use case in FIG. 10 may be different from the one in FIG. 9 in that, in the example use case of FIG. 9, the avatar is generated based on a user input that includes a text, an audio, or a combination thereof; while in the example use case of FIG. 10, the avatar is generated based on a user input that includes at least one visual media 1011 (e.g., image, video, etc.), in addition or in alternative to the text and/or audio as in the example use case of FIG. 9.

For instance, in the example use case of FIG. 10, the user may provide an image of a character/person, with/without a description (e.g., in text, audio, etc.) of the character/person. Accordingly, the chatbot may generate the avatar based on the image (and the descriptions of the character/person, if applicable), and output the avatar on chatbot interface 1000.

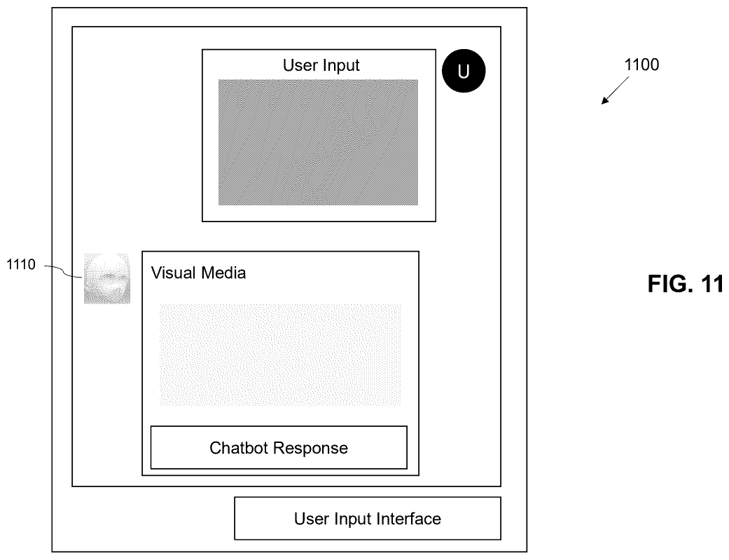

FIG. 11 illustrates a fifth example chatbot interface 1100, according to one or more example embodiments. The chatbot interface 1100 may be utilized or involved in one or more operations of process 200 to process 600. Chatbot interface 1100 may include components (e.g., conversation history section, user input interface, avatar, etc.) similar to those described above with reference to FIG. 7 to FIG. 10.

In the example use of FIG. 11, the chatbot icon (illustrated with the terms “AI” in FIG. 7 to FIG. 10) is replaced with an avatar 1110. The avatar 1110 may be dynamically or continuously updated by the chatbot based on the context of the conversation, thereby simulating or resembling real-time communication among the user and a character/person defined by the user. In some example implementations, the user icon (illustrated with the alphabet “U”) may be replaced with another avatar that resembles the user or the intended person/character, thereby enhancing the immersion experience of the user.

It is contemplated that the chatbot interfaces illustrated in FIG. 7 to FIG. 11 are merely examples and the scope of the present disclosure should not be limited thereto. Specifically, the chatbot interface may be configured in a different manner, may include additional/fewer components than as illustrated, the components and information may be presented in any other suitable manner, and the like, without departing from the scope of the present disclosure.

In view of the above, example embodiments may implement chatbot interfaces that enable the users to provide various types of inputs (including visual media such as images and videos). Further, the chatbot interface may effectively present or display the chatbot response, along with visual media and a personalized avatar that are dynamically updated according to the context of the conversations and communications between the users and the chatbot. Accordingly, example embodiments may provide effective communication among the chatbot and the users, with enhanced user experience and improved immersive interactions. Ultimately, example embodiments may provide higher levels of realism and deliver visual and conversational outputs that closely mimic human interactions, thereby improving the feasibility of applying the chatbot across diverse scenarios, such as customer service, virtual assistance, interactive entertainment, and the like.

### Example Embodiments: Implementation of Multimodal Chatbot

Descriptions of an example implementation of a multimodal chatbot are provided in the following with reference to FIG. 12. Specifically, FIG. 12 illustrates an example configuration 1200 for implementing the multimodal chatbot, according to one or more example embodiments.

As illustrated in FIG. 12, example configuration 1200 may involve a multimodal chatbot 1210 and a user device 1220. The multimodal chatbot 1210 may be implemented in a computing device (e.g., computing device 110 in FIG. 1) while the user device 1220 may be a device external from the computing device (e.g., external device 120 in FIG. 1). Thus, it may be understood that the communication between the multimodal chatbot 1210 and the user device 1220 may be performed via the communication between the computing device (that implements the multimodal chatbot 1210) and the user device 1220.

Referring to FIG. 12, the multimodal chatbot 1210 may be constituted of a plurality of response generators 1211, a plurality of rankers 1221, and a response builder 1231. It is contemplated that the multimodal chatbot 1210 in FIG. 12 may be simplified for illustrative and descriptive purposes, and the scope of the present disclosure should not be limited thereto. For instance, in some example implementations, the multimodal chatbot 1210 may further include other supporting or baseline components, such as intent handler that initializes conversations (e.g., with a welcome prompt) or terminates conversations (e.g., with a goodbye prompt), a filter that filters out inappropriate contents (e.g., offensive topics, sensitive terms, etc.), and the like, without departing from the scope of the present disclosure.

According to example embodiments, each of the response generators 1211, rankers 1221, and response builder 1231 may be composed of one or more AI/ML models that are trained, fine-tuned, and optimized for one or more respective operations. For instance, in the example of FIG. 12, the response generators 1211 may be composed of a plurality of AI/ML models 1211-1 to 1211-N (where N is any suitable natural number) that generate multiple responses to a user input and the rankers 1221 may be composed of a plurality of AI/ML models 1221-1 to 1221-N (where N is any suitable natural number) that rank and select one or more responses from the multiple responses provided by the response generators 1211. The response builder 1231 may (but not necessarily) utilize one or more AI/ML models, along with rule-based logics and/or formatting modules, to aggregate, convert, personalize, and adapt the selected response(s) for presenting to the user (e.g., via texts, audios, visual media, etc.).

According to example embodiments, the AI/ML models 1211-1 to 1211-N may include neural network models or LLMs that are trained and optimized for generating diverse and contextually relevant responses to the user input. By implementing multiple AI/ML models in parallel, the response generators 1211 may act as neural responders that do not require the implementation of rule-based decision gates to select which AI/ML models to activate. For example, whenever the user device 1220 provides a user input to the multimodal chatbot 1210, all AI/ML models 1211-1 to 1211-N may be triggered concurrently, thereby generating multiple responses to the user input. Since each of the AI/ML models 1211-1 to 1211-N may be trained differently and have different capabilities in processing and understanding the user input, the AI/ML models 1211-1 to 1211-N may generate multiple responses, each of which may be different from each other. As a non-limiting example, the AI/ML model 1211-1 may obtain a first visual media, while the AI/ML model may obtain a second visual media different from the first visual media. The generated responses may be provided to the rankers 1221 for further processing.

According to example embodiments, the AI/ML models 1221-1 to 1221-N may include AI/ML models that aggregate the responses generated by the response generators 1211 and assign scores thereto. For instance, the AI/ML models 1221-1 to 1221-N may be trained or optimized to assign confidence scores to each of the generated responses and select an appropriate response(s) based thereon. The AI/ML models 1221-1 to 1221-N may include BERT-based ranker models, GPT-based ranker models, and any other suitable types of AI/ML models that may rank and select the appropriate response(s) from among the responses generated by the response generators 1211. The AI/ML models 1221-1 to 1221-N may interoperate with each other in selecting the most appropriate response(s). As a non-limiting example, the rankers 1221 may obtain multiple visual media from the response generators, and may then rank each of the multiple visual media (e.g., assign confidence scores, etc.) and select the visual media that best matches the user input. Upon selecting the response(s), the rankers 1221 may provide the selected response(s) to the response builder 1231 for further processing.

Upon receiving the selected response(s) from the rankers 1221, the response builder 1231 may process (e.g., convert, enrich, package, generate re-prompt string, etc.) the selected response(s) into a chatbot response that match the user input (e.g., match the tones, stylistic configurations, etc,. of the user input), and then provide the chatbot response to the user device 1220 (e.g., via outputting or updating contents of a chatbot interface, etc.).

In view of the above, example embodiments of the present disclosure may implement the multimodal chatbot with a pure aggregation of response generators, such that every candidate AI/ML model can address the user input without hard-coded gates. Further, example embodiments of the present disclosure may utilize rankers to score and select responses generated by the response generators, thereby providing higher response quality and accuracy than single-path logic flows. It is contemplated that the example configuration in FIG. 12 is merely an example implementation of the multimodal chatbot, and the scope of the present disclosure should not be limited thereto.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code-it is understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for operating a multimodal chatbot, comprising:
receiving, via a chatbot interface, a user input, wherein the user input comprises at least one of: a text, an audio, a first image, and a first video;
obtaining a visual media associated with the user input, wherein the visual media comprises at least one of: a second image, a second video, and an avatar associated with a person; and
outputting, via the chatbot interface, the visual media.

2. The method according to claim 1,
wherein the visual media comprises at least one of: the second image and the second video; and
wherein the outputting the visual media comprises:
generating, based on the user input, a visual media retrieval query;
retrieving, based on the visual media retrieval query and from a database, a list of visual media associated with the user input;
selecting the visual media from the list of visual media; and
outputting the selected visual media via the chatbot interface.

3. The method according to claim 1,
wherein the visual content comprises at least one of: the second image and the second video; and
wherein the outputting the visual media comprises:
generating, based on the user input, a visual media generation instruction;
generating, based on the visual media generation instruction, a list of visual media associated with the user input;
selecting the visual media from the list of visual media; and
outputting the selected visual media via the chatbot interface.

4. The method according to claim 1,
wherein the visual content comprises at least one of: the second image and the second video; and
wherein the outputting the visual media comprises:
generating, based on the user input, a visual media retrieval query and a visual media generation instruction;
retrieving, based on the visual media retrieval query and from a database, a first list of visual media associated with the user input;
generating, based on the visual media generation instruction, a second list of visual media associated with the user input;
obtaining, based on the first list and second list of visual media, an ensemble of visual media;
selecting, from the ensemble of visual media and based on a confidence score, the visual media; and
outputting the selected visual media via the chatbot interface.

5. The method according to claim 1,
wherein the visual media comprises the avatar;
wherein the user input comprises a text defining the person; and
wherein the outputting the visual media comprises:
searching, based on the user input, an image associated with the person;
building, based on the searched image, an avatar figure;
obtaining, based on the user input, a visual media;
rendering, based on the avatar figure and the visual media, the avatar; and
outputting, via the chatbot interface, the rendered avatar.

6. The method according to claim 1,
wherein the visual content comprises the avatar;
wherein the user input comprises an image associated with the person; and
wherein the outputting the visual content comprises:
building, based on the image comprised in the user input, an avatar figure;
obtaining, based on the user input, a visual media;
rendering, based on the avatar figure and the visual media, the avatar; and
outputting, via the chatbot interface, the rendered avatar.

7. The method according to claim 5, wherein the outputting the visual media further comprises:
rendering, via the chatbot interface, a series of avatar movements, wherein the series of avatar movements comprises at least one of: body movements, lip movements, changes in an avatar gesture, changes in an avatar pose, and changes in an avatar facial expression.

8. The method according to claim 5, wherein the avatar figure is in two-dimensional (2D) and the rendered avatar is in three-dimensional (3D).

9. The method according to claim 1, further comprising:
generating, based on the user input, a chatbot response; and
presenting, via the chatbot interface, the chatbot response along with the visual media.

10. The method according to claim 9, wherein the chatbot response is visually distinguished from the visual media.

11. A computing device comprising:
a memory device configured to store computer-readable instructions; and
a processing device communicatively coupled to the memory device and configured to execute the instructions to implement a multimodal chatbot to:
receive, via a chatbot interface, a user input, wherein the user input comprises at least one of: a text, an audio, a first image, and a first video;
obtain a visual media associated with the user input, wherein the visual media comprises at least one of: a second image, a second video, and an avatar associated with a person; and
output, via the chatbot interface, the visual media.

12. The computing device according to claim 11,
wherein the visual media comprises at least one of: the second image and the second video; and
wherein the processing device is configured to execute the instructions to implement the multimodal chatbot to output the visual media by:
generating, based on the user input, a visual media retrieval query;
retrieving, based on the visual media retrieval query and from a database, a list of visual media associated with the user input;
selecting the visual media from the list of visual media; and
outputting the selected visual media via the chatbot interface.

13. The computing device according to claim 11,
wherein the visual media comprises at least one of: the second image and the second video; and
wherein the processing device is configured to execute the instructions to implement the multimodal chatbot to output the visual media by:
generating, based on the user input, a visual media generation instruction;
generating, based on the visual media generation instruction, a list of visual media associated with the user input;
selecting the visual media from the list of visual media; and
outputting the selected visual media via the chatbot interface.

14. The computing device according to claim 11,
wherein the visual media comprises at least one of: the second image and the second video; and
wherein the processing device is configured to execute the instructions to implement the multimodal chatbot to output the visual media by:
generating, based on the user input, a visual media retrieval query and a visual media generation instruction;
retrieving, based on the visual media retrieval query and from a database, a first list of visual media associated with the user input;
generating, based on the visual media generation instruction, a second list of visual media associated with the user input;
obtaining, based on the first list and second list of visual media, an ensemble of visual media;
selecting, from the ensemble of visual media and based on a confidence score, the visual media; and
outputting the selected visual media via the chatbot interface.

15. The computing device according to claim 11,
wherein the visual media comprises the avatar;
wherein the user input comprises a text defining the person; and
wherein the processing device is configured to execute the instructions to implement the multimodal chatbot to output the visual media by:
searching, based on the user input, an image associated with the person;
building, based on the searched image, an avatar figure;
obtaining, based on the user input, a visual media;
rendering, based on the avatar figure and the visual media, the avatar; and
outputting, via the chatbot interface, the rendered avatar.

16. The computing device according to claim 11,
wherein the visual media comprises the avatar;
wherein the user input comprises an image associated with the person; and
wherein the processing device is configured to execute the instructions to implement the multimodal chatbot to output the visual media by:
building, based on the image comprised in the user input, an avatar figure;
obtaining, based on the user input, a visual media;
rendering, based on the avatar figure and the visual media, the avatar; and
outputting, via the chatbot interface, the rendered avatar.

17. The computing device according to claim 15, wherein the processing device is further configured to execute the instructions to implement the multimodal chatbot to output the visual media by:
rendering, via the chatbot interface, a series of avatar movements, wherein the series of avatar movements comprises at least one of: body movements, lip movements, changes in an avatar gesture, changes in an avatar pose, and changes in an avatar facial expression.

18. The computing device according to claim 15, wherein the avatar figure is in two-dimensional (2D) and the rendered avatar is in three-dimensional (3D).

19. The computing device according to claim 11, wherein the processing device is further configured to execute the instructions to implement the multimodal chatbot to:
generate, based on the user input, a chatbot response; and
present, via the chatbot interface, the chatbot response along with the visual media, wherein the chatbot response is visually distinguished from the visual media.

20. A non-transitory computer-readable recording medium having recorded thereon instructions executable by a computing device to cause the computing device to implement a multimodal chatbot to perform a method comprising:
receiving, via a chatbot interface, a user input, wherein the user input comprises at least one of: a text, an audio, a first image, and a first video;
obtaining a visual media associated with the user input, wherein the visual media comprises at least one of: a second image, a second video, and an avatar associated with a person; and
outputting, via the chatbot interface, the visual media.
